(19) United States
(12) Patent Application Publication
(10) Pub. No.: US 2018/0102053 A1
(43) Pub. Date: Apr. 12, 2018

(54) Vehicular Location Monitoring and Space Sharing Method and System

(71) Applicants: Dustin Hillman, St. Paul, MN (US); Cassandra Hillman, St. Paul, MN (US)

(72) Inventors: Dustin Hillman, St. Paul, MN (US); Cassandra Hillman, St. Paul, MN (US)

(73) Assignee: Space Matter Alliance LLC, St. Paul, MN (US)

(21) Appl. No.: 15/461,657

(22) Filed: Mar. 17, 2017

Related U.S. Application Data
(60) Provisional application No. 62/496,282, filed on Oct. 11, 2016.

(51) Int. Cl. G08G 1/14; G06Q 10/02; G07B 15/02; G08G 1/16; G08G 1/0968

(52) U.S. Cl. CPC G08G 1/143; G06Q 10/02; G07B 15/02; G06Q 50/188; G08G 1/168; G08G 1/096894; G08G 1/146

(57) ABSTRACT

A vehicular location monitoring and space sharing process is coordinated by a management facility processing system. The management facility processing system receives vehicle locations from two driver processing systems as well as an intended location from one of the two driver processing systems. The management facility processing system matches an offering driver processing system, which identified its location as a potentially available parking location, with a requesting driver processing system, which specified an intended location proximal to the location of the offering driver processing system. The matching performed by the management facility processing system may take into account factors such as location, distance, congestion, timing constraints, and vehicle size. Post-parking ride sharing is also coordinated through the management facility processing system.

### CROSS-REFERENCES TO RELATED APPLICATIONS

This application claims the benefit of U.S. Provisional Application No. 62/496,282 filed Oct. 11, 2016, which is hereby incorporated by reference in its entirety.

### FIELD OF THE INVENTION

The present invention relates to a method and system to monitor vehicle locations, automatically match unrelated vehicles based on current and intended locations, and facilitate the sharing and exchange of vehicle spaces.

### SUMMARY OF THE INVENTION

The applicant has recognized a need for location identification, communication, and interaction management in order to create a facility for the sharing of valuable parking spaces. The system utilizes three technological elements, namely a management facility processing system, and first vehicle processing system associated with a moving vehicle, and a second vehicle processing system associated with the static vehicle. The management facility processing system is responsible for monitoring and initiating communications between the two vehicle systems, for identifying matches between the static vehicle system and the moving vehicle system, for confirming successful transfers, and for handling payments. The moving vehicle system is responsible for communications with the moving vehicle driver and the management facility processing system. The moving vehicle system must also identify the current location of the moving vehicle, must identify traffic patterns and approximate arrival times, and provide driving direction and other prompts to the moving vehicle driver. The static vehicle system is similar to the moving vehicle system in that it is responsible for communications with the static vehicle driver and the management facility processing system. The static vehicle system must also identify parking locations and recognize when a static vehicle driver is approaching the static vehicle.

In practice, the static vehicle driver will determine that they will soon be leaving their parking spot. Using the static vehicle system, the static vehicle driver will communicate their intention to sell their parking spot to the management facility processing system. By making this communication, the static vehicle driver will also be agreeing to wait a short period of time at their vehicle until a moving vehicle driver that wishes to park in the spot can arrive at the parking space. For instance, the static vehicle driver may indicate an agreement to wait for up to twenty minutes for the arrival of the moving vehicle. In one embodiment, the static vehicle system will identify the location of the parking space automatically, such as noting when the Bluetooth communication with the static vehicle is terminated when the automobile is turned off after parking. The static vehicle system would track this location in order to properly communicate the offer to transfer the parking space to the management facility processing system. In addition, the static vehicle system may use this location to determine when the static vehicle driver is approaching the parking location. At the appropriate time, the static vehicle system may alert the static vehicle driver that their parking location is in high demand, and they may be able to sell the spot through the management facility processing system. If the static vehicle driver agrees to transfer their parking location for a fee, they express this agreement to the static vehicle system, place a flag or other indicator on their car, and wait for the management facility processing system to match them with a moving vehicle that desires the parking space.

Meanwhile, a moving vehicle driver may use the moving vehicle system to request a parking space at the approximate location of the static vehicle. The moving vehicle system makes this request to the management facility processing system, and awaits communication that a match has been made.

When the management facility processing system receives the communications from the static vehicle system and the moving vehicle system, the management facility processing system attempts to make a match. A match is an indication that a static vehicle driver is willing to transfer a parking space at the time and location desired by the moving vehicle driver. The management facility processing system will determine that the moving vehicle's estimated arrival time at the parking space is within the time period that the static vehicle driver is willing to wait. Furthermore, the management facility processing system may determine whether or not the parking space is a parallel parking spot. If it is, the management facility processing system will use information that it knows about the static vehicle and the moving vehicle to ensure that the moving vehicle will fit into the same size parking space as the static vehicle. For instance, the management facility processing system may ensure that the moving vehicle is no larger (or only slightly larger) than the static vehicle if the static vehicle is attempting to transfer a parallel parking location.

If a match is made by the management facility processing system, the static vehicle system receives this information and informs the static vehicle driver when the moving vehicle is expected to arrive. The static vehicle system will also inform the static vehicle driver of the make, model, and color of the moving vehicle. In the preferred embodiment, the moving vehicle system will inform the management facility processing system of the moving vehicle's location and updated estimated arrival time, which is then communicated to static vehicle driver via the static vehicle system. The static vehicle system will alert the static vehicle driver when the moving vehicle's arrival is imminent (such as within 15 seconds of estimated arrival). When the static vehicle driver sees the moving vehicle, the static vehicle driver will leave the parking space and allow the moving vehicle to enter the space.

Meanwhile, the moving vehicle system also receives information about the match from the management facility processing system. The moving vehicle system informs the driver; identifies the make, model, and color of the static vehicle; and then begins providing directions to the moving vehicle driver to the parking space. These directions not only take the moving vehicle driver to the parking space, but also ensure that the driver is heading in the correct direction and in the correct lane for entering the parking space. The moving vehicle system informs the management facility processing system of the location of the moving vehicle to the management facility processing system during the drive to the parking space. When the moving vehicle driver approaches the parking space, the moving vehicle system will provide an audible prompt that they are approaching the parking space. The moving vehicle driver should also see the flag or other indicator on the static vehicle. The moving vehicle driver will wait for the static vehicle to exit the parking space, and then will take possession of the parking space.

The management facility processing system will monitor the static vehicle system and the moving vehicle system to ensure that a transfer of the parking space was successfully made. This will involve determining the time at which the static vehicle moves away from the parking space, and the time at which the moving vehicle enters the parking space. The time and location information necessary to make this determination is received by the management facility processing system directly from the two vehicle systems. Upon successful transfer, the management facility processing system will receive payment from the moving vehicle driver and provide payment to the static vehicle driver. The owner of the management facility processing system may provide only a percentage of the money received from the moving vehicle driver to the static vehicle driver, and keep the remainder for the operation of the system. If the transfer was not successful, and the system determines that one of the drivers did not live up to their agreement, management facility processing system may impose a financial penalty on the driver at fault and provide compensation for non-defaulting driver.

In one embodiment, the moving vehicle driver may indicate a desire to be driven by the static vehicle driver from a parking space to their desired destination. The management facility processing system will then attempt to identify a static vehicle driver with a parking space willing to perform this service for an additional fee. If such a match can be made, the static vehicle driver will wait for the moving vehicle driver after the exchange of the parking space. The static vehicle driver will then drive the moving vehicle driver to their desired destination and complete the transaction.

This disclosure and the associated drawings will occasionally describe embodiments relating to an exchange of a parking space frequently using abbreviations. For example, before an exchange of vehicles that occupy a parking space (PS), the first vehicle will move to the parking space, so it will be referred to as the moving vehicle (MV), and its driver or operator will be considered the moving vehicle driver (MVD). Immediately prior to the swap, the second vehicle will be static, occupying the parking space. That vehicle will be termed the static vehicle, abbreviated as SV, and its driver or operator as the static vehicle driver (SVD).

### BRIEF DESCRIPTION OF THE DRAWINGS

FIG. 1a is a conceptual drawing, illustrating a swap of a parking space between two vehicles.

FIG. 1b is a conceptual drawing, illustrating a swap of a parking space between two vehicles.

FIG. 2 is a block diagram, illustrating components of an embodiment of a parking space management system (PSMS).

FIG. 3 is a block diagram, showing components of an illustrative vehicle system.

FIG. 4 is a block diagram, showing components of an illustrative parking space management facility (PSMF).

FIG. 5 is a block diagram, showing some types of information that might be stored by an exemplary parking space management facility to facilitate its functions.

FIG. 6 is a block diagram, showing some types of logic that might be implemented by an exemplary parking space management facility to facilitate its functions.

FIG. 7 is a flowchart for an exemplary static vehicle system (SVS) to transfer a parking space to a mobile vehicle system (MVS), using an exemplary parking space management facility.

FIG. 8 is a flowchart for an exemplary mobile vehicle system to find an available parking spot from a static vehicle system, using an exemplary parking space management facility.

FIG. 9 is an illustrative flowchart for an exemplary parking space management facility to find a parking space, which is presently occupied by a static vehicle, for a moving vehicle.

FIG. 10 is an illustrative flowchart for an exemplary parking space management facility to find a mobile vehicle system to fill a parking space occupied by a static vehicle.

FIG. 11 is a flowchart for an illustrative process for cancellation by the moving vehicle driver.

FIG. 12 is a flowchart for an illustrative process for cancellation by the static vehicle driver.

### DETAILED DESCRIPTION OF EXEMPLARY EMBODIMENTS

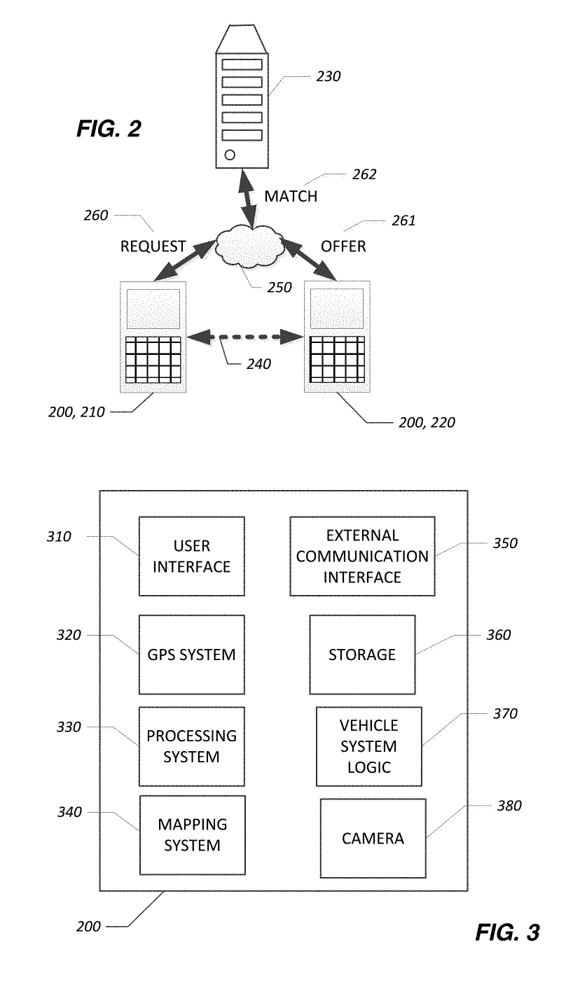

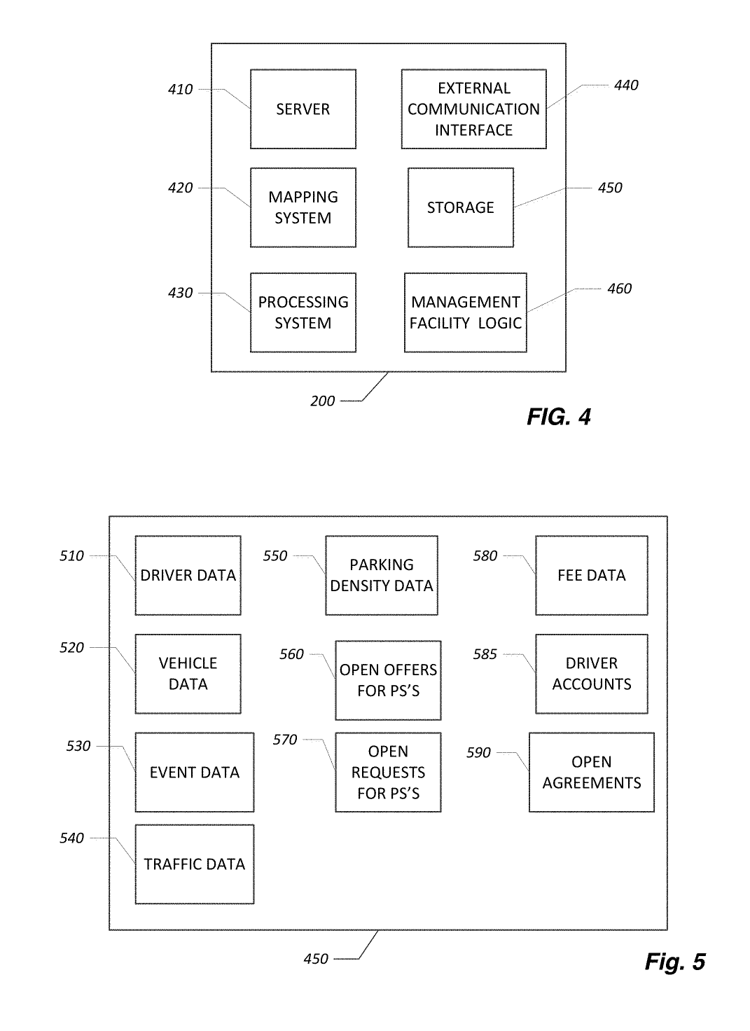

This description provides embodiments of the invention intended as exemplary applications. The reader of ordinary skill in the art will realize that the invention has broader scope than the examples described here. It should be noted from the outset that the drawings, and the elements depicted by the drawings, may not be to scale. Generally, reference numbers are keyed to the drawing of first appearance. For example, reference number 220 would appear first in FIG. 2; and 460, in FIG. 4. For clarity of the drawings, a given reference number that appears in a second figure will not necessarily be described a second time.

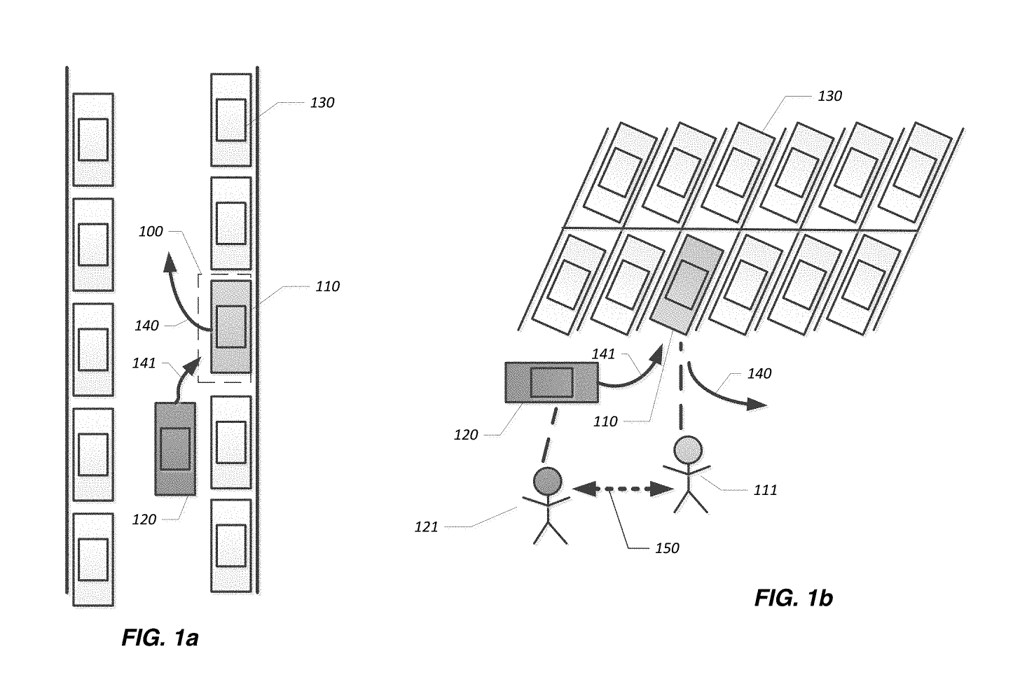

FIGS. 1a and 1b depict two variations of a commonly encountered parking space exchange scenario. FIG. 1a shows a crowded street; FIG. 1b, a crowded parking lot. In each case, moving vehicle 120 is driven by moving vehicle driver 121. Traditionally, under congested conditions, time and fuel are often wasted while moving vehicle driver 121 searches for a convenient parking space 100. If moving vehicle driver 121 is lucky, in an area congested with vehicles 130 that are filling the parking spaces, a parking space 100 occupied by a static vehicle 110, driven by static vehicle driver 111, might fortuitously pull out of the parking space 100, as depicted by arrow 140, so that moving vehicle driver 121 can take over the parking space 100 with moving vehicle 120. In some circumstances, however, such as during some sporting event, luck might not be enough for moving vehicle driver 121—all PSs 100 in a whole area might be fully occupied for hours.

FIG. 1b depicts an alternative to the above ad hoc approach. The two drivers 160 have entered into a prior agreement 150, whereby the static vehicle driver 111 promises the moving vehicle driver 121 to hold the parking space 100 for some interval, allowing the moving vehicle 120 to arrive and take the parking space 100 as the static vehicle 110 pulls out. Note that although the drivers 160 are depicted as outside of their vehicles 130 in FIG. 1b, that need not be the case to create such an agreement, or for the swap to be executed. Such an approach might be implemented as broadly illustrated by FIG. 2. Each driver has a respective vehicle system 200 that facilitates arrangement of the agreement 150 through a parking space management facility (parking space management facility) 230 (or simply management facility (MF) 230) which acts as intermediary in interaction 240 appropriate to arrange the agreement 150 and to carry it out successfully. The management facility 230 finds a match 262 between a request 260 from a mobile vehicle system 210 and an offer 261 of a parking space 100 from a static vehicle system 220.

We define a “communication system” to include any collection of communication systems, or any nesting or hierarchy of communication systems, recursively. A given communication system might include, for example, the Internet, WiFi, wired Ethernet, or any transmission of any wave or particle. FIG. 2 includes communication system 250, which facilitates communication of the parking space management facility 230 with mobile vehicle system 210 and static vehicle system 220. A communication system 250 includes one or more tangible hardware components. We define a “communication interface” to be a connection, which includes a hardware component, to any communication system.

In FIG. 2, each of the moving vehicle system (mobile vehicle system) 210 and the static vehicle system (static vehicle system) 220 are illustrated with a portable/mobile smart device, such as a smart phone or tablet computer. But any smart device such as one of the type illustrated by FIG. 3 might serve this role—for example, a laptop computer, or a computer that is integrated into the vehicle 130 itself.

It is worth noting that either driver 160 might be a virtual driver 160 of, for example, a self-driving vehicle 130. Or there might be two or more drivers 160 of the same vehicle 130, for example a vehicle 130 that is mostly self-driven, but that also has a human driver 160 who shares some of the driving functions. Interactions between the vehicle system 200 and the parking space management facility 230 in embodiments that include a virtual driver 160 may tend to be more automated than ones involving only human drivers 160, but such embodiments are within the scope of the invention.

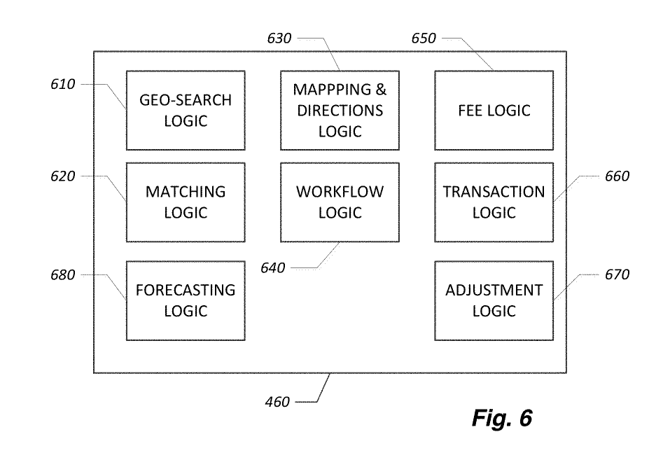

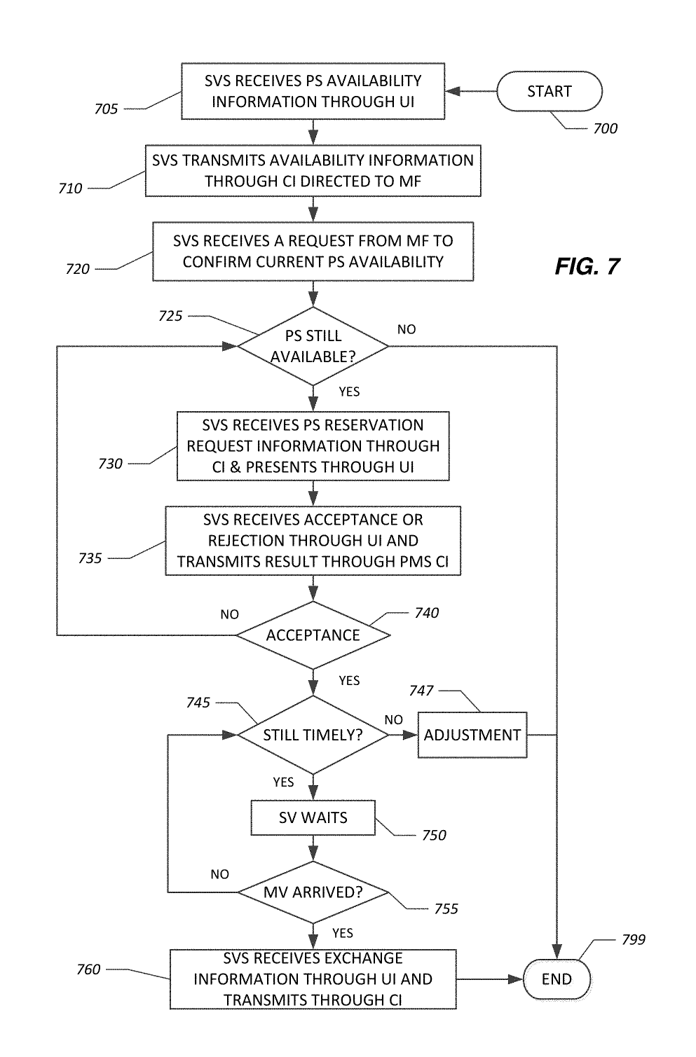

FIG. 3 is a block diagram, showing components of an illustrative vehicle system 200 that might serve as either a mobile vehicle system 210 or a static vehicle system 220. Any given vehicle system 200 might have some or all of the illustrated components. The functionality of a vehicle system 200 might be housed in a single device, or split or shared among two or more devices. The illustrated vehicle system 200 includes a user interface (UI) 310. A user interface 310 is any system or component that allows human driver 160 interaction with the processing vehicle system 200. This could include, for example, tangible controls, a graphical interface, and/or a speech-activated system. The illustrated vehicle system 200 has a vehicle processing system 330, which includes a tangible hardware processor. The illustrated vehicle system 200 includes vehicle system logic 370, such as that shown in FIG. 6. By “logic” we mean some combination of hardware and software instructions that includes conditional branching, such as illustrated by FIG. 7-10. Software instructions may be stored in vehicle storage 360, and executed by the vehicle processing system 330. By storage in this document we mean tangible electronic storage, such as a hard disk, solid state drive, volatile or non-volatile memory, or tape. In a self-driving moving vehicle 120, the vehicle system logic 370 might be integrated with the vehicle navigation system, causing the moving vehicle 120 to drive to the parking space 100 occupied by the static vehicle 110 automatically. The vehicle system 200 may also include data, such as that shown in FIG. 5. The vehicle system 200 might include a geolocation system 320, that might use, for example, the geographic position system (GPS), cell towers, or a cell service provider to locate the vehicle 130. The geolocation of the vehicle 130 might be transmitted to the parking space management facility 230 for mapping or time estimation. Communication between vehicle system 200 and the management facility 230 is through an external vehicle communication interface (VCI) 350, which includes at least one tangible hardware interface component and connects with communication system 250. The vehicle system 200 might include a vehicle mapping system 340 that might be used to direct the moving vehicle driver 121 to the geolocation of the static vehicle 110. The vehicle system 200 might include a camera 380. The camera 380 might be used by a moving vehicle driver 121 to photograph or video the moving vehicle 120, or by the static vehicle driver 111 to photograph the static vehicle 110 or the surroundings.

Note that some functionality that could be included in a vehicle system 200 might be handled either by that system alone, or in collaboration of the vehicle system 200 with the parking space management facility 230. For example, a management facility 230 might have more sophisticated mapping or direction functionality than a vehicle system 200. Or a management facility 230 might provide mapping or direction functionality if vehicle system 200 is not equipped at all for that. The vehicle processing system 330 might execute a software application, possibly downloaded through the vehicle communication interface 350 and stored in the vehicle storage 360, that acts in collaboration with the management facility 230. For example, a person who plans to offer parking spaces 100 to other drivers 160 might register in advance with management facility 230, providing for example, identification, financial information, vehicle information, and various preferences, and downloading the software application. Such registration might also make it more convenient if that person on occasion is in the role of moving vehicle driver 121. Registration might or might not be required for a moving vehicle driver 121. Finding a parking space 100 might simply be handled, for example, by accessing the management facility 230 on a website.

FIG. 4 is a block diagram, showing components of illustrative components of an exemplary parking space management facility 230. The management facility 230 might include one or more servers 410 that include or have access to management facility processing system 430 and management facility storage 450. The management facility processing system 430 contains a hardware processor. The management facility processing system 430 acts as intermediary that matches MVs 120 with SVs 110, records any relevant information in management facility storage 450, and executes management facility logic 460. The management facility storage 450 includes data such as that illustrated by FIG. 5, and may include software instructions that are executing by the management facility processing system 430. Some software instructions are part of management facility logic 460, which is described in more detail in FIG. 6. management facility 230 may include a management facility mapping system 420 for matching a moving vehicle 120 with a static vehicle 110, or for providing mapping and directions to vehicles 130. The management facility 230 has a management facility communication interface (MFCI) 440, for communicating with the vehicles 130 through the communication system 250. The management facility communication interface 440 may also be used to access external sources of data, such as event information (places and times, for example), traffic sources, weather sources, road closures, and detours.

FIG. 5 is a block diagram, showing some types of information that might be stored in, or accessed from, management facility storage 450 by an exemplary parking space management facility 230 to facilitate its functions. Driver data 510 might include some identification, banking information (e.g., credit card number, direct bank deposit number); history of prior use of the system; and possibly some indication of reliability regarding past agreements 150. Vehicle data 520 might include make, model, color, vehicle size (either vehicle 130 might range in size from a bicycle or motorbike to a large commercial vehicle), license plate state/country and number, and a photograph of the vehicle 130. A registered driver 160 might have such data for one or more vehicles 130 in management facility storage 450. Event data 530 might be used by the management facility logic 460 to predict places and times of traffic congestion. Other types of data, such as weather data and forecasts, might also be used in such prediction. Traffic data 540 relates to present congestion. In general, congestion influences, for example, (i) whether there is a demand for parking places; (ii) value of parking places in particular areas; and (iii) how long it will take a moving vehicle driver 121 to reach a given parking space 100. Parking density might be predicted, observed, or inferred from the record of incoming offers of PSs 100 and requests for PSs 100. When an offer 261 is received, it may be added to a database of open offers 560. Associated with the open offer 560 are any data about the driver, vehicle, location, timing, and compensation (if any). When a request 260 is received, it may be added to a database of open requests 570, along analogous information for the moving vehicle 120. Each of an offer 261 and a request 260 may have some associated time interval, which might be explicitly specified by the respective driver 160 or set to some default value by the management facility processing system 430, after which time the offer 261 or request 260 is removed from the “open” database. The management facility storage 450 may include fee data 580 or other data about compensation. When an agreement 150 is reached between a mobile vehicle system 210 and a static vehicle system 220 regarding a parking space 100, it added to a database of open agreements 590. Note that we are using the word “database” very broadly. For example, the database of open agreements 590 and the database of density data 550, for example, might be in a single database structure from a programming sense.

FIG. 6 is a block diagram, showing exemplary types of management facility logic 460 that might be implemented by an exemplary parking space management facility 230 to facilitate its functions. Note that in some embodiments, some of this work might be done instead by logic on a vehicle system 200, alone or in collaboration with the management facility processing system 430. The management facility logic 460 may include geo-search logic 610, to find the location of the static vehicle system 220 or the location of the mobile vehicle system 210. This logic might utilize, for example, GPS of a vehicle system 200; an address; a landmark; or feature identification of photographs taken in the vicinity of a static vehicle system 220. The management facility logic 460 may include matching logic 620 to match an open offer 560 with an open request 570, ensuring agreement about locations, timing, and any compensation. The management facility logic 460 may include mapping and directions logic 630, whereby the management facility 230 and the mobile vehicle system 210 can assist the moving vehicle driver 121 to arrive at the parking space 100 within a satisfactory time period. The management facility logic 460 may include workflow logic 640 to, among other things, handle interactions with the mobile vehicle system 210 and the static vehicle system 220 appropriately, as illustrated, for example, by FIG. 7-10. The management facility logic 460 may include fee logic 650, to calculate any compensation due. Depending on embodiment, fees might be fixed and set in advance. Or the drivers 160 might be allowed to negotiate the fee on an ad hoc basis. Or the fee might be variable and situational, calculated by the management facility 230, based on factors such as congestion, traffic, and timing. The management facility logic 460 may include correction or adjustment logic 670 to handle special circumstances, such as cancellation, impossibility, and breach of agreement 150. The management facility logic 460 may include forecasting logic 680, which might predict congestion, timing, and availability. Such predictions are relevant to feasibility of a possible match 262, and may also be relevant to fee setting.

FIG. 7 is a flowchart for an exemplary static vehicle system 220 to transfer a parking space 100 to a mobile vehicle system 210, using an exemplary parking space management facility 230. This flowchart describes illustrative functionality of a static vehicle system 220. After the start 700, the static vehicle system 220 receives 705 through its user interface 310 availability information about a parking space 100. This might be by interaction with a software application executing on the static vehicle system 220, possibly one previously downloaded from the management facility processing system 430. The information must be sufficient for a moving vehicle driver 121 to find the parking space 100, and should specify, if appropriate, any requirements about timing, fees, and size. Such sufficiency might be determined by the software application, and/or by logic of the management facility 230. The information might also include any relevant data about the driver 160 or the vehicle 130 that is not already in the management facility 230 database(s) or in vehicle storage 360. The static vehicle system 220 transmits 710 any relevant data about the parking space 100, the driver 160, the vehicle 130, and any other pertinent information concerning the offer 261 through the vehicle communication interface 350, directed to the management facility 230.

In some embodiments, the static vehicle system 220 will receive an indication from the static vehicle driver 160 that the parking space 100 will be made available at some point in the future. For example, a driver 160 may leave work and know that it takes fifteen minutes to walk from her office to the static vehicle 130. The driver 160 can indicate this in the static vehicle system 220, which will inform the management facility processing system 230 that the parking space 100 will be available in fifteen minutes. In other embodiments, the static vehicle system 220 will remember the location of the static vehicle 130 by monitoring when Bluetooth communication is lost when the vehicle was first parked at the parking space 100. The static vehicle system 220 can then identify that the driver 160 is approaching the vehicle, and prompt the driver to offer the parking space 100 for transfer. This prompt could also include an indication of the reward or monetary remuneration that would be made available if the parking space were successfully shared. The static vehicle system 220 could be programmed to prompt the static vehicle driver 160 only in circumstances where there are fewer parking spaces 100 being made available in a geographic area than there are moving vehicle drivers 121 looking for a space. If the static vehicle driver 160 agrees to make the space 100 available, the static vehicle system 220 would predict the time it will take to walk to the static vehicle 130, and inform the management facility processing system 230 of that availability time.

Some time may elapse before the static vehicle system 220 receives 720 a request from the management facility processing system 430 to confirm that the parking space 100 is still available. If 725 it is not, then the process ends 799. Otherwise, the static vehicle system 220 receives 730 information about a request 260 (or possibly a selection of two or more requests 260) through the vehicle communication interface 350 and presents any relevant information through the user interface 310. The static vehicle system 220 receives 735 a decision whether to accept or reject the request 260 through the user interface 310 and transmits the result to the management facility processing system 430. If 740 the static vehicle driver 111 has not accepted, then the search for an acceptable match 262 continues. If the request 260 is accepted, and assuming that the static vehicle driver 160 has not been waiting past the expected time period (step 740), the static vehicle driver 160 will place a flag or other indicator on the outside of their vehicle 110 and wait for the arrival of the moving vehicle 120 (step 750). The flow chart in FIG. 7 determines whether or not the moving vehicle 120 has arrived, and if not, the flow continues to the determination at step 745 as to whether the time period set for the arrival of moving vehicle 120 has passed. If the time period has expired, some adjustment 747 may need to be made in terms of compensation to the parties. For example, a fee might be refunded or prorated; a driver 160 might be suspended or removed from participation; a count might be kept of failures to deliver; a driver 160 might be given some coupon or discount by the management facility 230. When the moving vehicle 120 arrives (as determined by step 755), the static vehicle system 220 will trigger an alert to the static vehicle driver 111, such as an audible beep or verbal message, to prompt the immediate transfer of the parking space 100. The static vehicle driver 111 will confirm that the moving vehicle 120 that is now proximal to their vehicle matches the vehicle description provided by the static vehicle system 220. If so, the static vehicle driver 111 can vacate the parking space 100, the moving vehicle driver 121 can take the parking space 100, and the transfer is complete. Once the static vehicle system 220 and the moving vehicle system 210 confirm the exchange to the management facility processing system 230, the management facility processing system 230 can complete the exchange of compensation. The process ends 799.

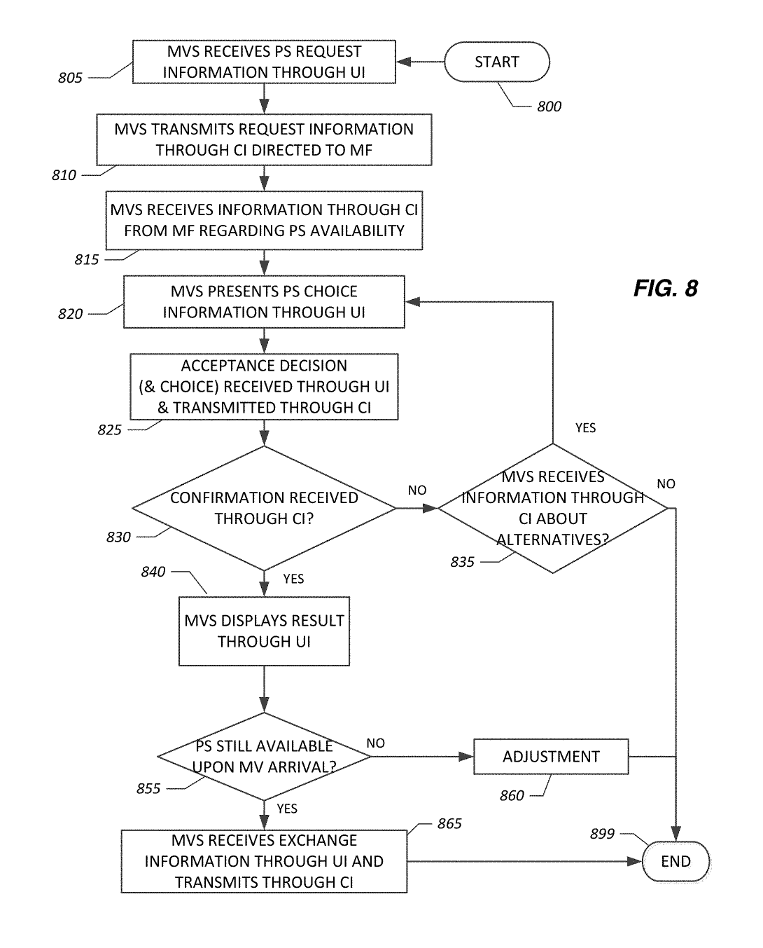

FIG. 8 is an exemplary flowchart for an exemplary mobile vehicle system 210 to obtain a parking space 100 from a mobile vehicle system 210, using an exemplary parking space management facility 230. This flowchart is similar to the previous one, but takes the perspective of the mobile vehicle system 210 rather than the static vehicle system 220. After the start 800, the mobile vehicle system 210 receives through the management facility communication interface 440 a request 260 to obtain a parking space 100, along with any specifications about the request 260. Much of the functionality in handling this request 260 on the mobile vehicle system 210 might be executed by a software application, possibly previously downloaded from the management facility, possibly in collaboration with management facility logic 460. The mobile vehicle system 210 transmits 810 this request 260 information, possibly along with relevant information that might be previously stored in vehicle storage 360, to the management facility processing system 430. The mobile vehicle system 210 subsequently receives 815 a selection of one or more offers 261 to choose from. The mobile vehicle system 210 presents 820 these options through the user interface 310. The decision about acceptance or rejection, and possibly a selection as well, is received by the mobile vehicle system 210 through the user interface 310, and transmitted 825 through the vehicle communication interface 350, directed to the management facility processing system 430. If, at step 830, a failure to confirm is received by the mobile vehicle system 210 through its vehicle communication interface 350, and if the mobile vehicle system 210 receives information about alternative selections, the selection process repeats, else the process ends. If a successful confirmation is received, then the mobile vehicle system 210 presents 840 the resulting offer 261 reservation through the vehicle communication interface 350. The management facility processing system 430 and/or the software application on the mobile vehicle system 210 may provide map information, directions, or driver guidance through the user interface 310 to the parking space 100. This guidance will ensure that the vehicle 120 will arrive on the correct side and correct lane of the street in order to safely enter the parking space 100. The moving vehicle system 210 will also calculate and continuously update an estimated time of arrival and communicate this information to the management facility processing system 230, so that it can be further communicated to the static vehicle system 220. When the moving vehicle 120 arrives proximal to the parking space 100, the moving vehicle system 210 will beep or otherwise indicate to the moving vehicle driver 121 that they have arrived and will remind the user of the appearance of the vehicle 110 currently occupying the parking space 100. In the preferred operation, that vehicle 110 will by flying a flag or have some other visual indicator that the vehicle is waiting for the moving vehicle 120. If the parking space 100 is no longer available upon arrival (step 855), then some adjustment 860 may be required. Otherwise, the agreement closes 865 and the moving vehicle driver 121 drives into the vacated parking space 100. The process ends 899.

In some embodiments, the moving vehicle driver 121 will begin driving to the destination before a match is made for a particular parking space 110. In these embodiments, the match will be made en route. In these cases, the match will be made pursuant to requirements specified by the moving vehicle driver 121 before beginning the route so as to avoid requiring the driver 121 to interact with the moving vehicle system 210 while driving. The moving vehicle system 210 and/or the management facility processing system 230 will complete the match, and the moving vehicle system 210 will begin providing directions to the driver 121 after the match is made.

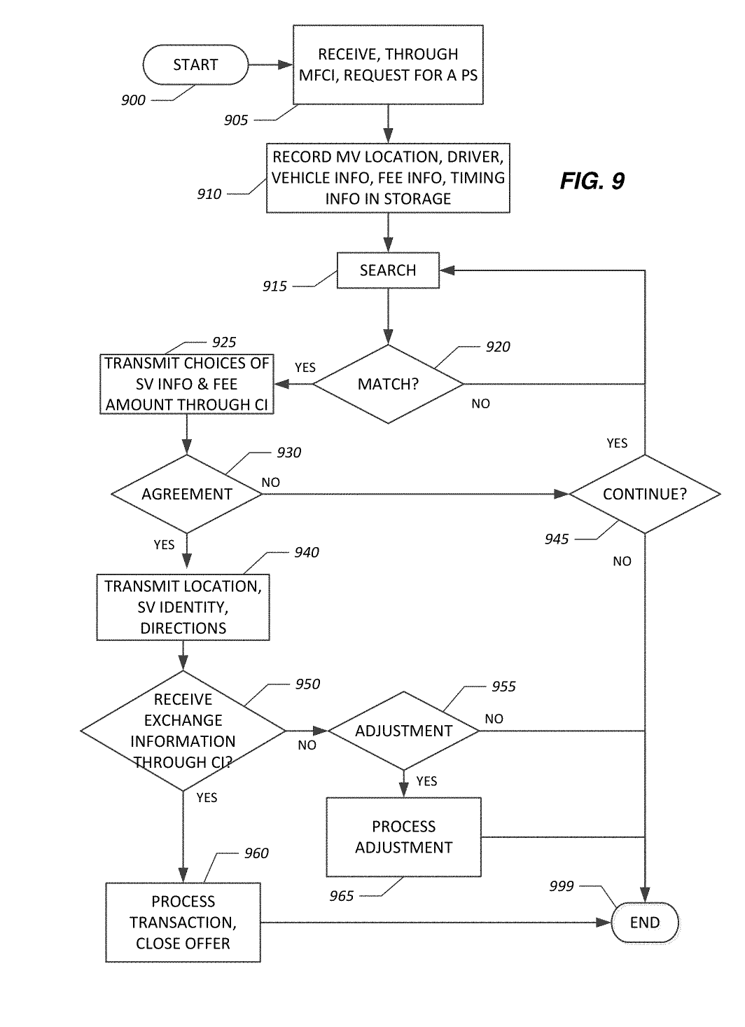

FIG. 9 is an illustrative flowchart for an exemplary parking space management facility for a moving vehicle 120 to find a parking space 100 that is presently occupied by a static vehicle 110. This flowchart is an example of a counterpart of FIG. 8, from the perspective of functionality of a management facility 230. After the start 900, the management facility processing system 430, through management facility communication interface 440, receives 905 a request 260 from a mobile vehicle system 210 for a parking space 100. The management facility processing system 430 records 910 in management facility storage 450 any relevant information about the request 260, such as the location, the size of the moving vehicle 120, timing information (such as the time when the moving vehicle driver 121 needs the parking space 100), any fee information, and any other terms of the request 260. The management facility processing system 430, using its management facility logic 460, searches 915 data in management facility storage 450 for one or more offers 261 concerning matching PSs 100. This search might consider various factors, such as locations of the two vehicles 130, congestion, weather, road conditions, event schedules, eyewitness reports, sizes of the moving vehicle 120 and the parking space 100, fee requirements, and any specific terms of the request 260 and of the offer 261. In some embodiments, size matching occurs only when the parking space 100 is a parallel parking space. In these circumstances, the moving vehicle 120 must be of a similar size or smaller than the static vehicle 110 before the match can be made. To determine whether the parking space 100 is a parallel spot, the static vehicle system 220 can request input regarding the parking space 100 from the static vehicle driver 111. Alternatively, the management facility processing system 230 can maintain a GPS-tagged database of parking locations and identify the type of parking space by simply examining the GPS location of the static vehicle 110. In addition to the size issue, matching will also consider the distance of the parking space 100 from the preferred destination of the moving vehicle driver 121, the willingness of the static vehicle driver 111 to provide a ride to the moving vehicle driver 121 (see further descriptions below), and the amount of time that the static vehicle driver 111 is willing to wait versus the estimated arrival time of the moving vehicle 120.

Matches may or may not be discovered 915 at the time of the search. If not, another search might be performed, possibly after some delay. If plausible matches are found 920, then these will be transmitted 925 by the management facility processing system 430 through its management facility communication interface 440, directed to the moving vehicle 120. The matches may be ranked when presented by the user interface 310 according to preferences. The preferences may be set by management facility 230, or the moving vehicle driver 121 may be given the option to specify a different ordering by the software application on the mobile vehicle system 210. If 925 the management facility processing system 430 does not receive 930 a commitment to one of the choices through the management facility communication interface 440, then the moving vehicle driver 121 might be given the option 945 to continue the search, and that decision is received by the management facility processing system 430. If the decision 945 is to continue, then another search is done; otherwise, the process ends 999. If agreement is reached between the two parties, then assuming that the corresponding offer 261 is still open, any further information related to the agreement 150 is transmitted 940 to the moving vehicle driver 121. Assuming that things go well, the management facility processing system 430 receives 950 an indication that the exchange of parking space 100 was completed. In this case, the management facility 230 then completes 960 the transaction, and closes the request 260. If the exchange was not completed, step 955 determines whether some adjustment is required. If so, the adjustment is processed 965. Such an adjustment might be required, for example, if the moving vehicle driver 121 fails to show up; if the moving vehicle driver 121 arrives on time, but the static vehicle driver 111 has already abandoned the parking space 100 and some other vehicle 130 is now occupying it; or if either driver 160 refuses to take steps to complete the transaction. The process ends 999.

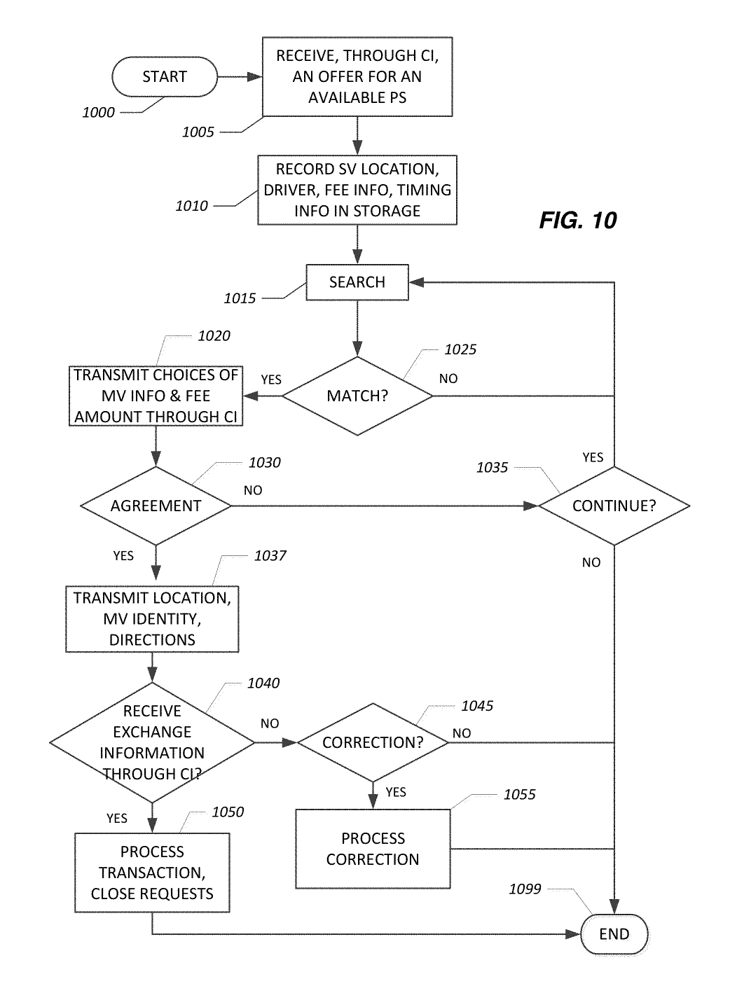

FIG. 10 is an illustrative flowchart for an exemplary management facility 230 to find a mobile vehicle system 210 to fill a parking space 100 occupied by a static vehicle 110. This flowchart is the counterpart of FIG. 7, from the perspective of the parking space management facility 230, and is similar to FIG. 9. After the start 1000, the management facility processing system 430 receives 1005 an offer 261 of parking space 100 from static vehicle system 220. The management facility processing system 430 records 1010 relevant information about the offer 261. A search is then conducted 1015 for matching requests 260. If there is one or more match, then information about the matching requests 260 from MVDs 121 is transmitted 1020 through the management facility communication interface 440, directed to the static vehicle driver 111, at step 1020. The management facility processing system 430 receives information that an agreement was not reached (step 1030), the moving vehicle driver 121 may be given the option whether to continue 1035 to search. If 1030 both parties have reached agreement, the management facility processing system 430 transmits identity and timing information to the static vehicle system 220 so that the static vehicle driver 111 will await the arrival of the identified moving vehicle 141. The management facility processing system 430 can receive an acknowledgement that the exchange of the parking space 100 has been made, or that it did not take place, from either the static vehicle system 220 or the mobile vehicle system 210. If the exchange has been completed, the management facility processing system 430 processes the transaction, handles the appropriate compensation, and closes the offer 261 and request 260 at step 1050. The method then ends 1999. If the exchange of parking space 100 does not take place as agreed, step 1045 determines whether a correction or adjustment is required. If so, the adjustment is processed 1055 and the process ends 1099.

Compensation to the static vehicle driver 111 can be based on a variety of algorithms. In one embodiment, the driver 111 is paid a flat rate for the parking space 100, which compensates the driver 111 for up to five minutes of waiting. The driver 111 is then compensated on a per-minute rate for waiting times longer than five minutes. This can be capped at twenty minutes. In some embodiments, static vehicle drivers 111 must agree to wait up to twenty minutes once a match is made. If the moving vehicle 120 has not arrived by that time, the static vehicle driver 111 may vacate the parking space 100 and still be compensated. In other embodiments, the static vehicle driver 111 may be compensated at greater rate after twenty minutes, but only if this waiting time and rate are agreed to by the moving vehicle driver 121. It is contemplated that the rates paid will vary depending on demand for parking spaces 100. If demand outstrips supply, the rates paid to the static vehicle driver 111 will increase. Of course, the rates charged to the moving vehicle drivers 121 would likewise increase, making it mandatory to clearly communicate the current rate being charged to the parties before any match is agreed upon. Ideally, the operator of the management facility processing system 230 will take a percentage of the fees paid by the moving vehicle drivers 121. It is possible to reward frequent users of the system by allowing the top static vehicle drivers 111 to receive a greater percentage of the fees earned.

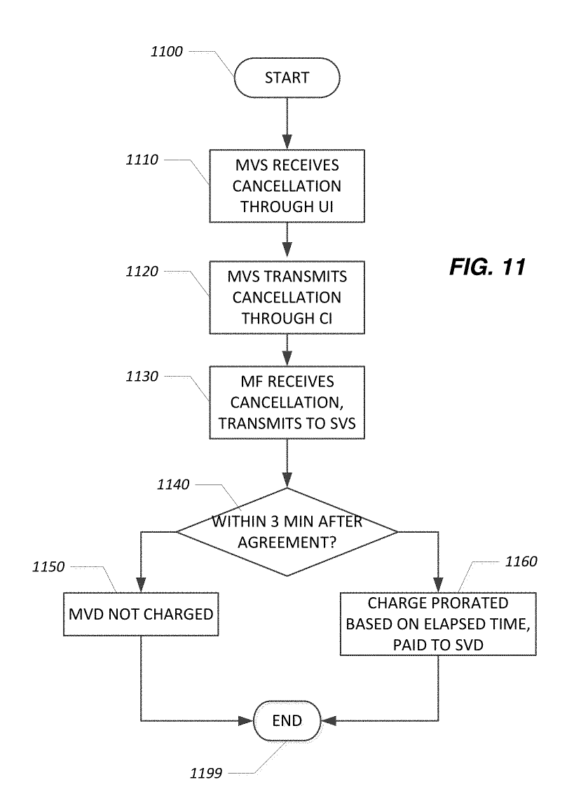

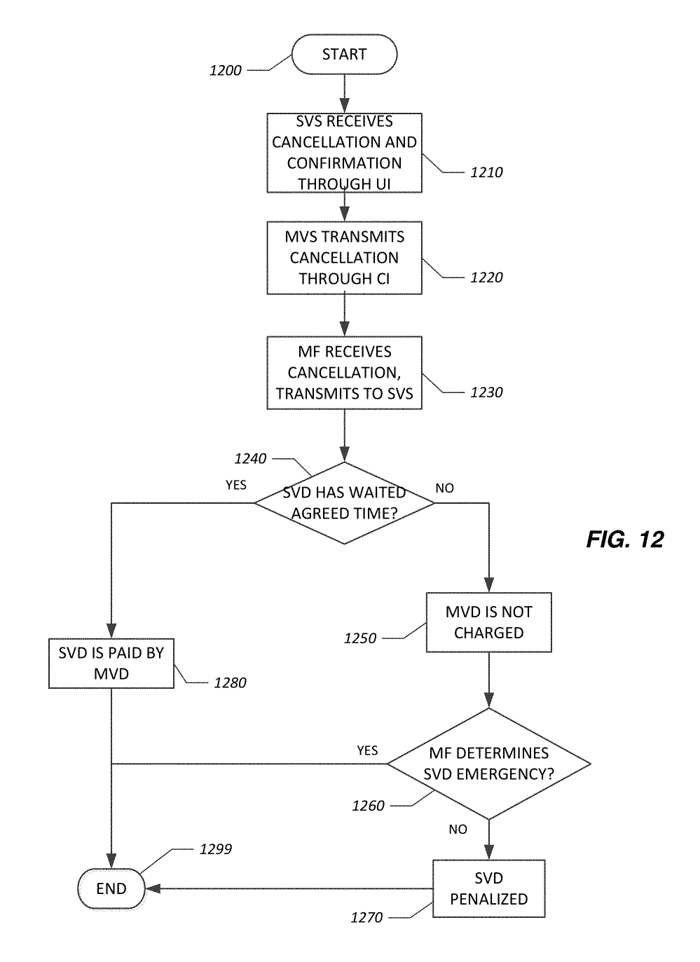

Not all embodiments involve payments between the parties. For example, a group or of people might simply help each other find parking spaces without compensation. Or some insurance or emergency assistance provider might offer parking service to customers. But other embodiments can involve money, and FIG. 11 and FIG. 12 illustrative flowcharts for payments when either the moving vehicle driver 121 or the static vehicle driver 111, respectively, cancels in such embodiments.

After the start 1100 in FIG. 11, the mobile vehicle system 210 receives 1210 a request to cancel through its user interface 310. After possibly displaying a warning about consequences, and possibly receiving confirmation, the mobile vehicle system 210 transmits 1120 the cancellation through its vehicle communication interface 350 to the management facility processing system 430. The management facility processing system 430 receives the cancellation, and transmits 1130 it to the static vehicle system 220, and terminates the agreement 150. If 1140 the elapsed time of cancellation occurred within some previously specified interval (e.g., 3 minutes) after the agreement 150 was made, then 1150 the moving vehicle driver 121 is not charged. Otherwise 1160, the moving vehicle driver 121 is charged a prorated amount based on the elapsed time. The process ends 1199.

Similarly, after the start 1200 in FIG. 12, the static vehicle system 220 receives 1210 a request to cancel through its user interface 310. After possibly displaying a warning about consequences and possibly receiving confirmation, the static vehicle system 220 transmits 1220 the cancellation through its vehicle communication interface 350 to the management facility processing system 430. The management facility processing system 430 receives the cancellation, and transmits 1230 it to the mobile vehicle system 210, and terminates the agreement 150. If 1240 the static vehicle driver 111 has waited the minimum amount of time agreed upon, then the management facility processing system 430 causes the static vehicle driver 111 to be paid 1280 by the moving vehicle driver 121. Otherwise 1250, the moving vehicle driver 121 is not charged. The static vehicle driver 111 might provide evidence to the management facility processing system 430 that the static vehicle driver 111 had to leave because of some emergency situation. If the management facility 230 determines that there was not an emergency, then the static vehicle driver 111 may be penalized 1270. Such determination might require human intervention at the management facility 230, so in that case, the management facility processing system 430 would need a user interface. As an example of a penalty, if the management facility 230 requires registration to participate in the parking service program, then the static vehicle driver 111 might be fined, or the registration might be canceled. The process ends 1299.

There might be some dispute over whether the agreement 150 was fully executed. For example, the static vehicle driver 111 claims that the static vehicle 110 vacated the parking space 100 and the moving vehicle 120 then occupied it. But the moving vehicle driver 121 claims that the static vehicle 110 was gone when the moving vehicle 120 timely arrived, and the parking space 100 was already filled by some unidentified third party. There are various ways such disputes could be handled, but if both vehicle systems 200 include an operating GPS or other precise geolocation system, then the management facility 230 might be able to resolve the dispute definitively, depending upon the geolocations of the two vehicles 130.

Note that the entire parking service process might be fully automated, to the point where the moving vehicle driver 121 simply gives an oral command through the user interface 310 of the moving vehicle 120 to find a parking place. Of course, this would require that various preferences of the driver 160 be stored in the mobile vehicle system 210 and/or the management facility storage 450 in advance. With advance preparation, the static vehicle driver 111 could similarly connect with an appropriate moving vehicle driver 121 with a single command. Indeed, if the moving vehicle driver 121 and the static vehicle driver 111 are both self-driving vehicles, the two vehicles could form and execute an agreement 150 in response to mere specifications from the two drivers 160 about where they want to go, and when.

In an alternative embodiment, the moving vehicle driver may be driving to a particular destination, such as a concert venue, a sporting event, or public festival. They may be willing to pay for a particular parking space that is close to the entrance to that event. However, it may be that no static vehicle driver is willing to transfer a parking space that is near the venue. In these instances, the moving vehicle driver may indicate a desire to be driven from a further parking space to the event entrance. The static vehicle driver may also indicate a willingness to provide this service for an additional fee. If a match can be made between these drivers, the static vehicle driver will vacate the parking space when the moving vehicle approaches, but will not leave the immediate area. The moving vehicle driver will park their vehicle, and then get into the static vehicle. The static vehicle driver will then drive the moving vehicle driver to the entrance and complete the transaction.

In most cases, whenever the moving vehicle driver 121 requests access to a parking space 100, and then completes acquisition of the parking space 100, the management facility processing system 230 will charge the moving vehicle driver 121 through the moving vehicle system 210. In at least one embodiment, it is possible for the moving vehicle driver 121 to share the cost of acquiring a parking space 100. In this embodiment, the moving vehicle system 210 incorporates a friends list of other users. These other users may be in the same car as the moving vehicle driver 121, and may agree to share in the cost of acquiring the parking space 100. To do this, they can access their own personal computing devices and indicate that they are willing and interested in sharing the cost of the parking space 100. This indication can be made by communicating user identification information from the users' personal computer devices to the management facility processing system 230 (as well as the identity of the moving vehicle driver 121). The management facility processing system 230 will match this willingness to share in the cost of the parking space 100 with the current request 260 made by the moving vehicle driver 121, and divide the cost. The division of the cost can be made evenly between the parties, or according to the wishes expressed in the communication from the various computer devices to the management facility processing system 230.

It is also possible to send a coupon or certificate from one user to another, which allows the recipient of the coupon to park for free. The sender of the coupon would bear the cost of the recipient's acquisition of the parking space 100. This would allow, for example, the host of a dinner party to send parking coupons to their guests, allowing their guests to park close to the host's residence without incurring the cost of acquiring nearby parking spaces 100.

In other embodiments, rather than having friends volunteer to pay for the parking, or having one friend send a coupon to another, the moving vehicle driver 121 will initiate the sharing of the cost of the parking space 100. In this embodiment, the moving vehicle driver 121 will send a request to one or more friends on their friend list asking for contributions to pay for the parking space 100. These friends may be friends that are raiding with the moving vehicle driver 121, or may be friends that are remote to the transaction. Upon receiving this request, some of the friends may agree to contribute to the cost of the parking space 100. The management facility processing system 230 would then split the cost between the moving vehicle driver 121 and the contributing friends, preferably according to the preferences expressed by the participants.

Of course, many variations of the above concepts are possible within the scope of the invention. The present invention is, therefore, not limited to all the above details, as modifications and variations may be made without departing from the intent or scope of the invention. Consequently, the invention should be limited only by the following claims and equivalent constructions.

What is claimed is:

1. A vehicle location monitoring and space sharing method, comprising:
a) receiving at a parking space management facility through an electronic communication interface to an external communication system, offers from a plurality of offering vehicle processing systems to vacate respective vehicle locations, and for each such offer:
(i) storing offer information in tangible electronic storage, the offer information including:
(A) offering vehicle location information,
(B) offering driver information, and
(C) offer termination time specifying when the offer will terminate,
(ii) terminating the offer if not accepted by the offer termination time;
c) receiving through the electronic communication interface a request from a requesting vehicle processing system, the request including:
(A) requesting vehicle location information,
(B) requesting driver information,
(C) request termination time specifying when the request will terminate if not accepted, and
(D) an intended destination location;
d) searching the electronic storage for an offer that matches the request, taking into consideration the following elements:
(i) the offering vehicle location information and the intended destination location, and
(ii) estimated travel time from the requesting vehicle location to the offering vehicle location;
e) transmitting, through the electronic communications interface, information characterizing a matching offer for a particular parking space to the requesting vehicle processing system, and receiving agreement to the matching offer;
f) transmitting, through the electronic communications interface, information characterizing the request to a matching offering vehicle processing system that transmitted the matching offer, and receiving agreement to the request; and
g) receiving, through the electronic communications interface, confirmation, that an exchange of the parking space has occurred.

2. The method of claim 1, the searching for an offer further taking into consideration:
(v) sizes of the two vehicles.

3. The method of claim 1, further comprising:
h) after the receiving step, transferring by the facility a payment from a requesting driver account to an offering driver account.

4. The method of claim 3, wherein the amount of the payment is a function of parking congestion near the parking space.

5. The method of claim 3, wherein the amount of the payment is uniform throughout a particular geographic area.

6. The method of claim 3, wherein the amount of the payment is negotiated between the two vehicle processing systems.

7. The method of claim 1, wherein the estimation of travel time considers information selected from a set consisting of: a distance between the vehicle locations, recurring events, scheduled events, traffic density, road closures, detours, and weather.

8. The method of claim 1, further comprising:
h) transmitting a first offer from a first offering vehicle processing system associated with a first offering vehicle.

9. The method of claim 8, wherein the first offer specifies a first offering vehicle location that is determined by the first offering vehicle processing system from GPS.

10. The method of claim 8, further comprising:
i) receiving information pertaining to the first offer through a user interface of the first offering vehicle processing system.

11. The method of claim 8, wherein the first offering vehicle is a self-driving vehicle, and the first offer and relevant information are automatically generated by the first offering vehicle itself in response to an indication received through a user interface of an intent to leave a first parking space.

12. The method of claim 1, further comprising:
h) transmitting the request from the requesting vehicle processing system, wherein the requesting vehicle processing system is associated with a requesting vehicle.

13. The method of claim 12, wherein the requesting vehicle location is determined by the requesting vehicle processing system from GPS.

14. The method of claim 12, further comprising:
i) receiving through a user interface of the requesting vehicle processing system information pertaining to the request.

15. The method of claim 12, wherein the requesting vehicle is a self-driving vehicle, and the request and relevant information are automatically generated by the vehicle itself in response to input receive through a user interface to go to the intended destination location.

16. The method of claim 1, wherein the offer information further includes an indication of willingness to drive a short distance after the exchange of the parking space, further wherein the request further includes a request to obtain a drive from the parking space to the intended destination location, and still further wherein the receiving of step d) includes receiving confirmation that the drive from the parking space to the intended destination location was completed.

17. A system, comprising:
a) a parking space management facility, including
(i) a server, with a processing system that includes a tangible hardware processor,
(ii) a communication interface whereby the server communicates with a communication system external to the management facility,
(iii) storage that contains
(A) driver data for a plurality of drivers, which includes, for each driver in the plurality, identification information,
(B) vehicle data, for a plurality of vehicles, which includes for each vehicle in the plurality, color, make, model, and license plate number,
(C) offer data, for a plurality of parking space availability offers, specifying a driver, a vehicle, a location, an offer expiration time, and a latest time for waiting to vacate the space, and
(D) request data, for a plurality of parking space requests, specifying a driver, a vehicle, and an expiration time, and
(E) agreement data, for a plurality of agreements, specifying a request-offer pair, and
(iv) logic, including software instructions that are executed by the processor, that
(A) estimates relevant travel times between locations,
(B) estimates relevant parking densities, and
(C) compares time requirements and location requirements in matching requests to offers.

18. The system of claim 17, further comprising:
b) a requesting vehicle processing system, that transmits request data pertaining to a request through a communication interface to the management facility.

19. The system of claim 18, further comprising:
c) an offering vehicle processing system, that transmits offer data pertaining to an offer through a communication interface to the management facility.

20. A method, comprising:
a) receiving by an offering vehicle smart system information specifying an offer of a parking space, which is at the time of the transmission is occupied by the offering vehicle;
b) transmitting by the system information characterizing the offer through an external electronic communication interface to a remote parking space management facility;
c) within a previously specified interval, receiving through the external interface from the facility information characterizing a request for the parking space from a requesting vehicle smart system, and specifying a time to hold the parking space;
d) within the holding time, transmitting through the external interface from the facility a confirmation that the offering vehicle has vacated the parking place and that the requesting vehicle has replaced it.
